(19) United States
(12) Patent Application Publication
(10) Pub. No.: US 2022/0018805 A1
(43) Pub. Date: Jan. 20, 2022

(54) ION-SENSITIVE FIELD EFFECT TRANSISTOR

(71) Applicant: LUXEMBOURG INSTITUTE OF SCIENCE AND TECHNOLOGY (LIST), Esch sur Alzette (LU)

(72) Inventors: Cesar PASCUAL GARCIA, Esch sur Alzette (LU); Serena ROLLO, Esch sur Alzette (LU)

(21) Appl. No.: 17/292,498

(22) PCT Filed: Nov. 20, 2019
(86) PCT No.: PCT/EP2019/081951

§ 371 Date: May 10, 2021

(30) Foreign Application Priority Data
Nov. 28, 2018 (LU) 101020

(51) Int. Cl. G01N 27/414

(52) U.S. Cl. CPC G01N 27/4146; G01N 27/4145

(57) ABSTRACT

An ISFET or ISFET-based sensor includes a source terminal, a drain terminal and a transistor channel between the source terminal and the drain terminal, where the ISFET or ISFET-based sensor also includes a fin extending between the source terminal and the drain terminal, the fin including the transistor channel, the fin having opposite sides with charge-sensitive surface for forming an interface with an analyte solution and an insulating barrier between the charge-sensitive surface and the transistor channel located centrally between the opposite sides of the fin, such that the transistor channel has a height-to-width ratio of at least 10.

### TECHNICAL FIELD

The disclosure generally relates to sensors for the detection of chemical and biological species, in particular to ion-sensitive field effect transistors (ISFETs), and devices implementing such transistors, such as ISFET-based biosensors, including DNA-ISFETs, Immuno-ISFETs, enzyme FETs, etc.

### BACKGROUND

An ISFET is a field-effect transistor (FET) configured for measuring ion concentrations in a solution. An ISFET-based (bio)sensor is a modification of an ISFET, in which the interface has been functionalized to selectively trap specific (bio)molecules, bearing a global charge or globally neutral bearing local charges, that affect locally the conductive channel.

ISFETs were first developed in the 1970s, as an alternative to the glass electrodes for pH and ion measurements. The structure of an ISFET is comparable to that of a MOSFET (metal-oxide-semiconductor field-effect transistor) except that the gate dielectric is exposed to the analyte solution, so that ions in the solution influence the gate potential and exert electrostatic control on the source-drain current. A reference electrode in contact with the analyte solution is used to determine the potential of the analyte solution. For a fixed potential at the reference electrode (reference potential), only the surface potential at the gate dielectric changes with the pH and so does the source-drain current.

FETs based on silicon nanowires (NVV) have been devised for a new generation of label-free real-time sensors for the detection of chemical and biological species. The three-dimensional configuration of silicon NWs makes them more efficient than the planar ISFETs (so-called ribbon-type ISFETS) to detect ultra-low concentrations of molecules. This is due to a better gating and to the more efficient geometry in diffusion-limited processes, i.e. at low concentrations of the target ions. Low detection limits have been shown for different biomolecules including DNA and proteins. SiNW-based ISFETs use fabrication methods of the semiconductor industry and, due to their low footprint, operation current and voltages, they are compatible with complementary metal oxide semiconductor (CMOS) circuits. This makes them suitable for applications that require massive multiplexing, such as, e.g. personalized precision medicine.

Due to their small capacitance, SiNW ISFETs exhibit short response times, which qualifies them for real-time sensing. However, the actual limitation is the electrostatic screening of the ions in an electrolyte solution. For this reason, most experiments combine two processes, incubation in isotonic conditions, followed by measurement after washing with a liquid at lower ionic strength.

US 2015/0268189 A1 discloses a device called “FinFET” fully immersed in a sensing environment (liquid, gas, solid). The proposed device is a variant of a NW ISFET. It comprises a silicon fin that vertically protrudes from the surface of the bulk silicon substrate. Its vertical architecture and multiple gate control provide higher stability and higher signal-to-noise ratio with respect to its planar counterpart, the ISFET, and common SiNWs. The height-to-width ratio of the disclosed FinFETs amounts to about 3. The fins are produced with a taper at their bottom portions or are completely detached from the substrate. Accordingly, the transistor channels of the FinFETs are electrically insulated from one another and from the silicon substrate by gaps and/or silicon oxide. Therefore, the transistor channels effectively correspond to nanowires with vertically stretched cross sections. US 2015/0268189 A1 also discloses a FinFET fabrication method.

SiNW-FETs still have problems of repeatability and reliability. Due to the small cross section of their transistor channels, fabrication and functionalization defects have an increased risk of leading to punctures and inhomogeneity of the NWs. Efforts thus have to be made to control composition and homogeneity of the NWs. SiNWs produce relatively small signals, which makes their integration challenging because of the built-up voltage necessary to polarize highly resistive devices. NW arrays measured in parallel can increase the total signal and mitigate the lack of reliability. The downside of this approach is that the overall device footprint is increased. Arrays of parallel NWs thus suffer from reduced efficiency at low analyte concentrations in diffusion-limited processes and are less suited for massive multiplexing due to the increased footprint.

### BRIEF SUMMARY

The disclosure proposes an alternative ISFET, in which the above-identified issues are mitigated.

According to an aspect of the disclosure, an ISFET or ISFET-based sensor includes:
a source terminal, a drain terminal and a transistor channel between the source terminal and the drain terminal;
a fin extending between the source terminal and the drain terminal, the fin including the transistor channel, the fin having opposite sides with a charge-sensitive surface for forming an interface with an analyte solution and an insulating barrier between the charge-sensitive surface and the transistor channel located centrally between the opposite sides of the fin.
   The transistor channel, i.e. the region in the interior of the fin the conductivity of which changes as a function of the concentration of the analyte, has a height-to-width ratio of at least 10, a width in the range from 50 nm to 300 nm, a height in the range from 500 nm to 10 μm and a length in the range from 5 μm to 30 μm. Regarding dimensional indications used in the context of the present disclosure, “length” refers to the direction extending from the source terminal to the drain terminal, “height” and “width” are transversal to the length. More specifically, “width” refers to the direction that is transversal to the length and parallel to the substrate of the ISFET or ISFET-based sensor and “height” refers to the direction that is transversal to the length and perpendicular to the substrate. It should be noted that the transistor channel may be generally planar but it could also have a curved length extension. Width and height are preferably uniform over the entire length of the transistor channel. Alternatively, width and height could be uniform throughout a central portion of the transistor channel (there could be tapered end portions)—in this case, the height-to-width ratio is to be measured in the central portion. The length of the central portion preferably amounts to at least two thirds of the total length of the transistor channel.

The fin is preferably configured (in terms of width, height, length, doping (dopant species and concentration) of the transistor channel, thickness and material of the insulating barrier, etc.) depending on the target analyte concentration range (maximum and minimum detectable analyte concentrations). When the ISFET or ISFET-based sensor is designed as a depletion-mode transistor (i.e. with decreasing conductivity when the analyte concentration increases), the fin is preferably configured so as to have the desired sensitivity and to reach full depletion for the wanted maximum analyte concentration. Without wanting to be bound by theory, it is a rule of thumb that, in order to reach high sensitivity (low detection limits), the size of the ISFET or ISFET-based sensor has to be decreased. This is why one would expect an ISFET with a high-aspect-ratio fin (and transistor channel) to significantly worsen the detection limits in comparison with a NW ISFET. However, the inventors have surprisingly found that an ISFET or ISFET-based sensor according to the disclosure does not only not significantly worsen the sensitivity but also benefits from improved reliability and higher signal-to-noise ratio. It will be appreciated that the dimensions of the ISFET or ISFET-based sensor render the device especially suitable for functionalization with nucleotides, nucleotide-binding sites, peptides, proteins or protein-binding sites. The available surface is indeed such that the obtainable number of functionalization sites is high enough that small defects or statistical fluctuations of the density of functionalization sites has only a low or negligible impact on the response function of the ISFET or ISFET-based sensor. It can thus be expected that ISFET or ISFET-based sensors of a given production batch will have essentially the same response function. If the available surface were smaller, steric effects and/or statistical fluctuations in the density of functionalization sites could have a large impact on the response function, making it necessary not only to calibrate each device individually but also to reject a possibly high proportion of devices not meeting the specification requirements. With larger dimensions and thus larger available surface, the sensitivity of the ISFET or ISFET-based sensor might degrade, making it less suitable for applications characterized by low target analyte concentrations and/or low volumes in absence of microfluidic flow.

An embodiment of an ISFET according to the disclosure was implemented as a pH sensor with a p-doped transistor channel configured (in terms of dimension and doping) to turn from fully conductive to nearly fully depleted in a pH range of ˜8 units. The relationship between the electrostatic effect of the analyte and the physical height of the fin has deep consequences for the performance of the ISFET. The two-dimensional mobility of charge carriers in the transistor channel, which results from the large surface area of the fin, leads to a decreased impact of surface defects on the transistor performance when compared with NW ISFETS. The chosen configuration provided a larger cross-section compared to traditional NWs (or NW arrays) responsible for a large output current with an improved linear response. The size increase of the tested ISFET with respect to NWs did not suffer from a significantly reduced sensitivity. In case of an ISFET or ISFET-based sensor with an n- or p-doped Si transistor channel, the dopant concentration therein preferably amounts to at most 5·10¹⁷/cm³.

The ISFET or ISFET-based sensor presented herein thus combines the advantages of NW-based sensors with the reliability of planar devices, while also the advantages of three-dimensional biosensors can be preserved in particular embodiments.

The insulating barrier preferably comprises an oxide layer. The oxide layer preferably has a thickness of 30 nm or less, e.g. 25 nm or less, 20 nm or less, or 15 nm or less, 10 nm or less. The oxide layer could comprise or consist of binary or ternary oxide(s), e.g., SiO₂, Al₂O₃, Ta₂O₅, ZrO₂, CeO₂, DyScO₃, LaAlO₃, GdScO₃, LaScO₃ HfO₂, La₂O₃, TiO₂, YSZ (yttria-stabilized zirconia) and combinations of these. Among the binary oxides, SiO₂, Al₂O₃ and HfO₂ are preferred, SiO₂ because of its excellent interface with Si, Al₂O₃, because is one of the oxides most commonly implemented in atomic layer deposition (ALD) processes and HfO₂ because of its high dielectric constant, its large band offset with Si, its thermodynamic and kinetic stability and its good interface with Si. Additionally or alternatively, the insulating barrier could comprise a dielectric that is not an oxide, e.g., Si₃N₄.

Preferably, the insulating barrier comprises a surface functionalization that renders the charge-sensitive surface selective for a particular species of ions or (bio)molecules. The functionalization layer could provide a surface allowing specific ions or biomolecules (e.g. nucleotides like DNA, RNA, PNA strands and aptamers, antibodies or antibody fragments, peptides, polypeptides, proteins or protein fragments, selective sugars, enzymes) to bind thereto. It may be worthwhile noting that the (bio)molecules need not be ions (i.e. bearing a net overall charge) but could be globally neutral, bearing local charges having an influence on the transistor channel.

The fin preferably protrudes from a semiconductor substrate, e.g. a Si substrate.

The transistor channel could be formed of n-doped silicon. Alternatively, it could be formed of p-doped silicon. The transistor channel could further work in accumulation-mode or depletion-mode.

The ISFET or ISFET-based sensor is preferably implemented as a junction-less field-effect transistor, i.e. without designed doping concentration gradients between the transistor channel and the source and drain, respectively. Junction-less field-effect transistors are typically implemented as heavily doped Si nanowires, which are narrow enough to allow for full depletion of carriers when the transistor is turned off. In the context of the present disclosure, however, the junction-less field-effect transistor is implemented by a nano-fin allowing for carrier mobility in two dimensions (when the transistor channel is not fully depleted) rather than one, as in a nanowire.

The transistor channel preferably has a height-to-width ratio of at least 15. Higher height-to-width ratios, e.g., 20, 25, 30 or even more are not excluded.

Preferably, the fin has a width in the range from 50 nm to 250 nm. Preferably, also the height lies in the range from 1 μm to 5 μm.

The length of the transistor channel preferably lies in the range from 7 μm to 20 μm. The length of the central portion (having constant width and height) of the transistor channel preferably lies in the range from 3 μm to 20 μm, more preferably in the range from 5 μm to 18 μm.

A further aspect of the disclosure relates to an ion- or molecule-sensitive device that comprises
an ISFET or ISFET-based sensor as described herein,
a chamber for receiving an analyte solution, the fin of the ISFET or ISFET-based sensor being arranged so as to protrude into the chamber, and
a reference or pseudoreference electrode arranged for contacting the analyte solution.

According to a preferred embodiment, the ion- or molecule-sensitive device comprises a microfluidic sensor, e.g. a microfluidic protein sensor, a microfluidic biomolecule sensor or a microfluidic DNA sensor.

Yet a further aspect of the disclosure relates to a microfluidic platform comprising a plurality of ion-sensitive devices and/or microfluidic sensors.

Still a further aspect of the disclosure relates to a method of using an ion- or molecule-sensitive device, a microfluidic sensor or a microfluidic platform, wherein the analyte solution is led into the chamber and an electrical quantity dependent on conductance of the ISFET or ISFET-based sensor (e.g. voltage drop and/or current between the source and drain terminals) is measured when the analyte solution rests with respect to the chamber.

In the present document, the verb “comprise” and the expression “comprised of” are used as open transitional phrases meaning “consist at least of” or “include”. The terms “vertical” and “horizontal” are not to be taken as designating absolute orientations but refer to orientations that are perpendicular or parallel, respectively, to the substrate.

### BRIEF DESCRIPTION OF THE DRAWINGS

The accompanying drawings illustrate several aspects of the present disclosure and, together with the detailed description, serve to explain the principles thereof. In the drawings:

FIG. 1: is a schematic, partially perspective view of an ISFET according to an embodiment of the disclosure;

FIG. 2: is a cross-sectional view of the fin of the ISFET of FIG. 1;

FIG. 3: is an illustration of the electrolyte/dielectric and dielectric/semiconductor interfaces according to the two-capacitor model;

FIG. 4: is the equivalent circuit diagram of the interfaces of FIG. 3;

FIG. 5: is an illustration of a transistor channel of an ISFET according to an embodiment of the disclosure when immersed in an electrolyte with a low concentration of target ions;

FIG. 6: is an illustration of the transistor channel of FIG. 5, when the concentration of target ions is higher;

FIG. 7: is an illustration of the transistor channel of FIG. 5, when the concentration of target ions is still higher;

FIG. 8: shows the transfer characteristics (left-hand diagrams) and the flatband voltages as a function of pH (right-hand diagrams) of three tested ISFETs in accordance with the disclosure;

FIG. 9: shows the output characteristics of the three tested ISFETs at a fixed reference voltage for different pH values of the analyte solution (graphs (a), (b) and (c)), the conductance of the tested devices as a function of electrolyte pH at different fixed values of the reference potential (graphs (d), (e) and (f)) and the relative conductance changes (graphs (g), (h) and (i));

FIG. 10: shows the comparison between the conductance of one of the tested ISFETs vs. the change in the surface potential ψ₀ (or pH, indicated on top scale) and the conductance of a nanowire with a height-to-width aspect ratio of 1;

FIG. 11: shows the conductances of FIG. 10 normalized to the respective cross-sectional areas;

FIG. 12: shows the current vs. time characteristics of one of the tested ISFETs (graph (a): for varying pH; graph (c): for varying reference voltage; graph (d): for varying pH but at a different electrolyte concentration) and the diffusion times of the analyte ions corresponding to the measurements of graph (a) (graph (b));

FIG. 13: is an illustration of the diffusion of ions or molecules towards ISFETs of different geometrical configurations;

FIG. 14: is a cross-sectional view of the fin of an ISFET-based biosensor comprising an ion- or molecule-selective surface functionalization;

FIG. 15: is a schematic enhancement of detail A of FIG. 14 according to a first variant of a surface functionalization;

FIG. 16: is a schematic enhancement of detail A of FIG. 14 according to a second variant of a surface functionalization.

### DETAILED DESCRIPTION

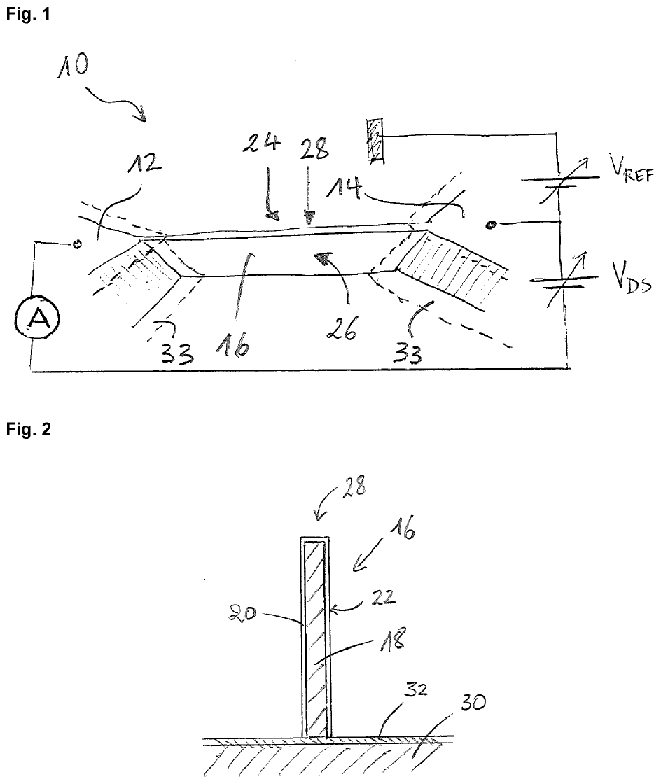

FIGS. 1 and 2 illustrate an ISFET 10 according to an embodiment of the disclosure. The ISFET 10 (hereinafter also FinFET) includes a source terminal 12, a drain terminal 14 and a fin 16 extending between the source and drain terminals 12, 14. The fin 16 includes therein a transistor channel 18, which is separated from the analyte solution by an insulating barrier 20 comprising one or more dielectric layers, e.g. oxide layers, and having a charge-sensitive (e.g. ion-sensitive) surface 22. The transistor channel is located centrally between the opposite lateral faces 24, 26 of the fin 16. The insulating barrier 20 covers the lateral faces 24, 26 and the narrow top face 28 of the fin 16. The fin 16 protrudes from a semiconductor substrate 30, from which the fin 16 is electrically insulated by a dielectric layer 32. Source and drain areas are encapsulated in a passivation layer 33, preventing a shortcircuit across the analyte solution.

The transistor channel 18 has a height-to-width ratio of at least 10 or more, e.g. 12, 15, 20, 25 or even more.

FIGS. 14 to 16 illustrate variants of the FinFET 10 shown in FIGS. 1 and 2. Specifically, the FinFET of FIGS. 14 to 16 comprises a surface functionalization 38 on the insulating barrier 20 of the fin 16. The surface functionalization 38 renders the charge-sensitive surface 22 ion- or molecule-selective, i.e. allows only specific molecular species to bind to it. In all other regards, the structure of the fin 16 of FIGS. 14 to 16 is the same as that shown in FIGS. 1 and 2.

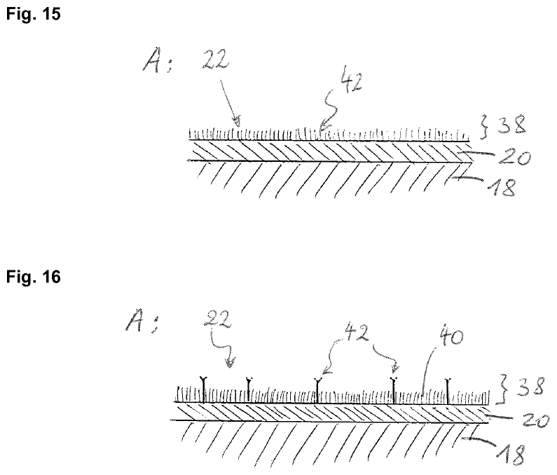

FIG. 15 is a schematic illustration of a first variant of a surface functionalization 38 consisting of analyte-specific receptors 42. FIG. 16 is a schematic illustration of a second variant, wherein the surface functionalization 38 comprises an antifouling coating 40 (e.g. of polyethylene glycol) as well as analyte-specific receptors 42. Various types of surface functionalization exist and the present disclosure is not limited to a specific kind thereof.

The behavior of the transistor channel 18 as a function of analyte ion concentration (H⁺ in this example) will in the following be discussed for a p-doped Si transistor channel covered with an SiO₂ barrier layer in contact with the analyte solution. The width of the depletion region W_{D} inside the semiconductor may be described by a model that takes into consideration the chemical and electrostatic equilibria. The first effect is the interaction of the protons with the silanol groups on the oxide surface, which can be protonated or deprotonated. At chemical equilibrium, be a charge on the surface generates a surface potential ψ₀. The relation between this surface potential and the pH of the analyte solution is described by the Nernst equation:

$$\frac{\partial {Ψ}_{0}}{\partial {pH}_{B}} = - 2.303 \frac{kT}{q} α \qquad Eq . 1$$

where k is the Boltzmann constant, T the temperature in K, q the elementary charge, pH_{B} the pH of the bulk and α a sensitivity parameter that takes into account the buffer capacity of the oxide and the double layer capacitance.

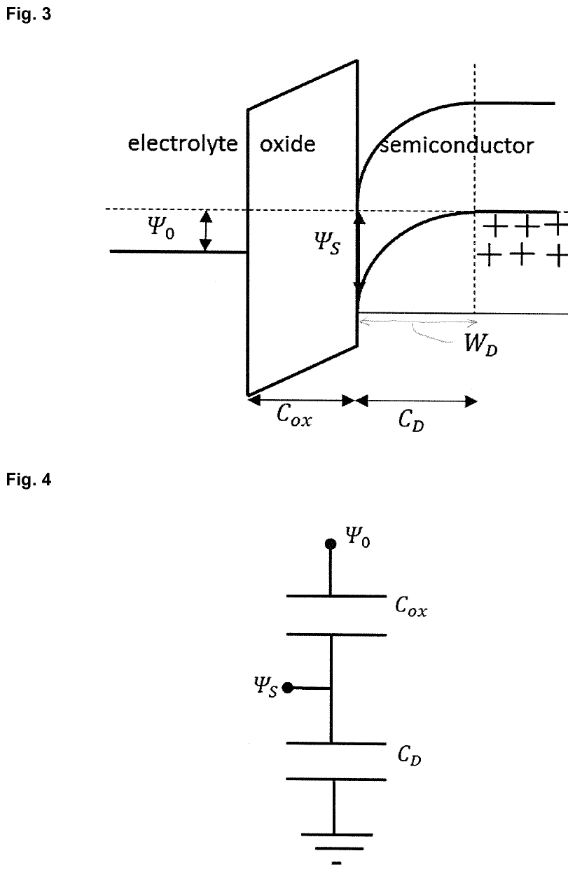

Electrostatic equilibrium is reached through the redistribution of charge carriers inside the semiconductor. This can be described with the Poisson equation:

$$\frac{{d}^{2} {Ψ}_{S}}{{dx}^{2}} = - \frac{ρ}{{ɛ}_{Si} {ɛ}_{0}} = - \frac{{qN}_{A}}{{ɛ}_{Si} {ɛ}_{0}} \qquad Eq . 2$$

where ψs is the potential at the oxide/semiconductor interface, ρ the charge density inside the semiconductor that in the approximation of total depletion is equal to the doping (N_{A}), ε₀ the electric constant (vacuum permittivity) and εₛᵢ is the relative permittivity of silicon. The relationship between the two equilibrium phenomena may be described through the two-capacitor model, where the oxide and the depleted region are considered as capacitors in series, as illustrated in FIGS. 3 and 4. At equilibrium, the capacitors bear equal charges Qₒₓ and Q_{D}:

Qₒₓ=(Ψ₀−V_{fg}−Ψ_{S})Cₒₓ=Ψ_{S}C_{D}=Q_{D} Eq. 3

where V_{fg} is the front gate potential, normally applied to the electrolyte through a reference electrode, Cₒₓ the areal capacitance of the oxide (Cₒₓ=ε₀ε_{SiO2}/tₒₓ, with tₒₓ tₒₓ representing the thickness of the oxide) and C_{D} the areal capacitance of the depletion layer

$$( {C}_{D} = \frac{{ɛ}_{0} {ɛ}_{Si}}{{W}_{D}} ) .$$

Combining equations 2 and 3, W_{D} may be expressed as a function of ψ₀ and production parameters such as the dopant density N_{A} of the semiconductor and the thickness of the sensing oxide:

$${W}_{D} ( {N}_{A} , {t}_{ox} , {Ψ}_{0} ) = - \frac{{ɛ}_{Si}}{{ɛ}_{o x}} {t}_{o x} + \sqrt{\frac{{ɛ}_{Si}^{2}}{{ɛ}_{o x}^{2}} {t}_{ox}^{2} + 8 \frac{{ɛ}_{Si} {ɛ}_{0} ( {Ψ}_{0} - {V}_{fg} )}{{qN}_{A}}} \qquad Eq . 4$$

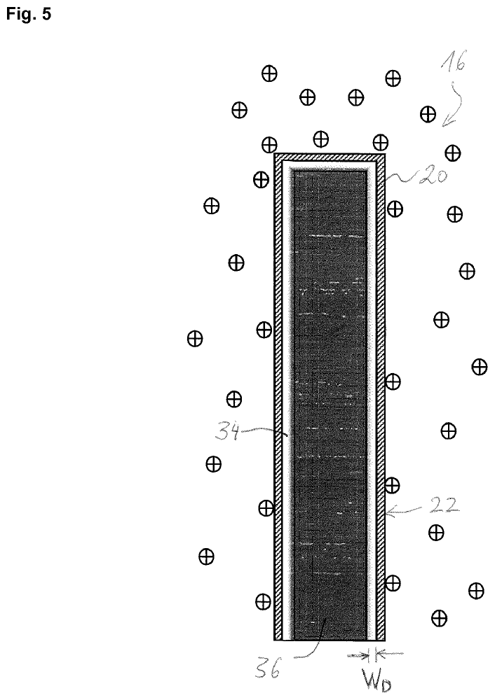

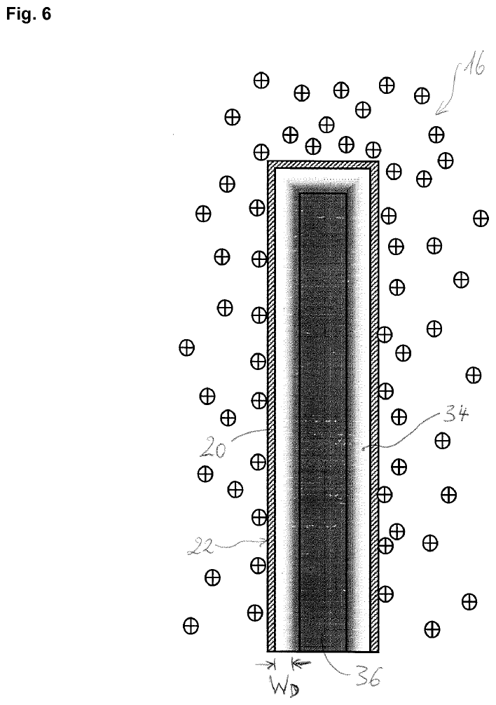

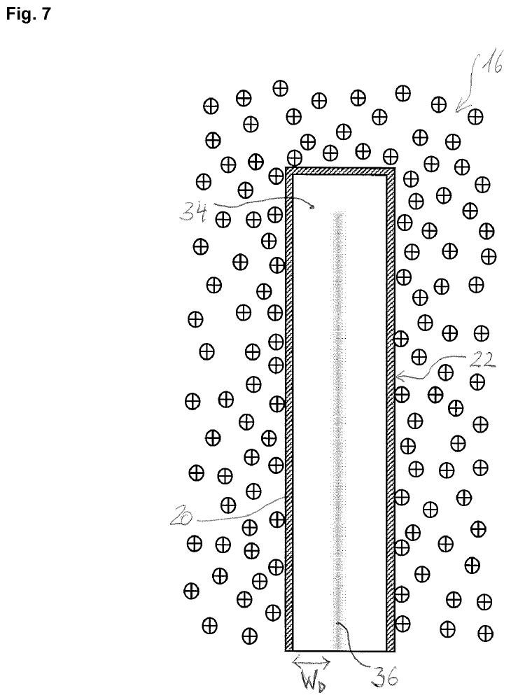

Because of Eq. 1, W_{D} can also be expressed as a function of the pH, N_{A} and tₒₓ. For a p-doped semiconductor in acidic conditions (higher concentration of protons, low pH) the width of the depleted region of the transistor channel is greater than in basic conditions. For a given ISFET, W_{D} becomes a function of the pH only. This can be explained by the more protonated silicon oxide surface, which creates a repulsive electric field inside the fin. FIGS. 5, 6 and 7 illustrate the increase of the depleted region 34 in the transistor channel (and thus the decrease of the conductive region 36) for decreasing pH of the surrounding solution.

The variation of the conductance (G) of the transistor channel may be calculated by Ohm's law, using W_{D} to calculate the effective change in the cross-section of the conducting region 36:

$$Δ G = σ \frac{Δ S}{L} = σ \frac{( w - 2 {W}_{D} ) ( h - {W}_{D} )}{L} = σ \frac{( wh - {wW}_{D} - 2 {hW}_{D} + 2 {W}_{D}^{2} )}{L} \qquad Eq . 5$$

where σ represents the conductivity of the bulk silicon. ΔS the variation of the conductive cross section, L the length of the channel, w the height of the transistor channel and h the height of the transistor channel.

### Examples

Si FinFETs according to the disclosure were fabricated by anisotropic wet etching on a p-doped silicon-on-insulator (SOI) substrate with a 2±0.1 μm thick silicon device layer (<110> oriented) with conductivity of 0.115 Ω·cm (equivalent doping 10¹⁷/cm³) and a 1 μm thick buried SiO₂ from Ultrasil Corporation.

A thin (40 nm thick) layer of SiO₂ was grown on top of the substrates using a Rapid Thermal Chemical Vapour Deposition (RTCVD) reactor with a pure oxygen flow of 200 sccm at atmospheric pressure and 1000° C. during 190 s. Then, a 200 nm thick ma-N2043 negative electron beam (e-beam) resist layer was spin-casted at 2000 rpm for 1 minute. The resist was baked at 120° C. for 5 minutes. Patterning of the FinFET design was carried out using a FEI-HELIOS microscope equipped with a XENOS lithography system. After developing in ma-D developer for 1 minute with manual stirring, the patterns were transferred by reactive ion etching (RIE), using a plasma of 25 W at a pressure of 75 Torr during 15 minutes to leave a few nm of un-etched SiO₂ outside the patterns, which was later removed by dilute HF isotropic treatment to leave a smooth silicon surface. The samples were then wet-etched in a 25% wt. tetramethylammonium hydroxide, 8.5% vol of isopropanol water solution at 43±1° C. under automatic stirring (250 rpm). Etching was carried out until the device layer was completely removed outside the patterned areas. The mask was then removed with HF. A 20 nm SiO₂ layer was then grown using RTCVD. Ohmic contacts were patterned by scanning UV laser lithography (SLL). A second SLL step was carried out to define lead contacts to the devices. These were deposited using a combination of e-beam evaporation (5 nm of Ti then 50 nm of Au), followed by 100 nm of conformal sputtering to overcome the step of the MESA Ohmic contacts. UV SSL patterning with SU-8 photoresist was used to passivate all areas except the sensing areas. Each sample was then mounted on a printed circuit board and wire-bonded. The metal wires were passivated using a commercial liquid epoxy with medical grade Loctite Hysol M-31CL.

The resulting fins had a total length (L) of 14 μm measured. The height (h) of the fins was 2 μm. In the following, FinFETs produced as described above, having fin widths (W) of 150, 170 and 190 nm, respectively, will be discussed in more detail. The aspect ratios W/h were 13.3 (for “device 1”), 11.8 (for “device 2”) and 10.5 (for “device 3”).

Electrical characterization was carried out with a Keithley 2614HB DC source-meter using two-wire configuration to obtain the current-voltage (I-V) curves. The FinFETs were polarized using a calomel reference electrode (BioLogic R-XR300). The electrolyte was a mixture of 1:1 buffer (0.1 M potassium phosphate, citric acid, boric acid solution with 0.1 M potassium nitrate solution) with a starting pH of 2.5, titrated with a 0.1 M KOH solution towards more basic pH values. Milli-Q water was the solvent for all buffers. A commercial calibrated pH sensor (Sentron S1600) was used to monitor the pH and temperature. The temperature of the experiments was stabilized by using a bath placed on a hotplate.

The p-doped FinFETs work in depletion mode for positive charges like protons. The output and transfer characteristics of the FinFETs were measured at fixed pH=7. The devices showed linear drain source current vs drain source voltage (I_{ds} vs V_{ds}) characteristics with a coherent dependence on the reference electrode voltage (V_{ref}). Drain current correlated with fin width. The current through the FinFETs increased for a decreasing reference voltage, as expected for a p-type ISFET. From the measured output and transfer characteristics, a clear dependence of drain current on reference and drain voltages could be observed. The tested FinFETs had maximum transconductance of 263±0.06 nS, which is comparable to values of NW-based ISFETs.

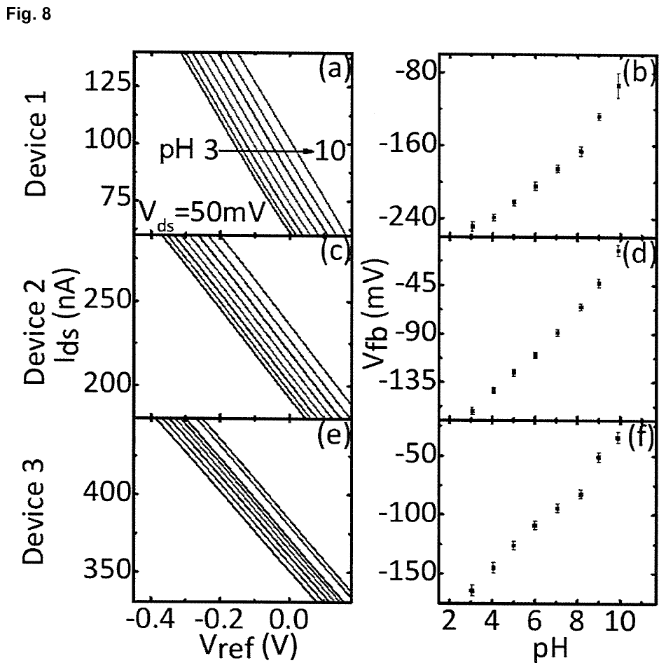

After basic characterization, the FinFETs' responses to pH variation was tested. The transfer characteristic was measured by sweeping V_{ref} from −1.5 to 1.5 V at a fixed V_{ds} (50 mV) and varying the electrolyte pH by manual titration from acidic towards basic values. The obtained transfer characteristics (FIG. 8 (a), (c) and (e)) show that the drain current increases with increasing pH of the analyte solution.

The corresponding flat band voltages (V_{f}b) of the FinFETs at different electrolyte pH values were evaluated by calculating the first derivative of the transfer characteristics. Specifically, the values of V_{fb} as function of the pH were calculated from the minimum of the transconductance (δI_{ds}/δV_{ref}). To get a more accurate position of the minimum, the transconductance was fitted around the minimum value with a gaussian. V_{fb} as a function of electrolyte pH is shown in FIG. 8 (b), (d) and (f) for the three tested FinFETs. The flat band voltage of the FinFETs increased with increasing pH. Due to the deprotonation of the surface hydroxyl groups at the fin surface, there is an increase in majority charge carriers (holes) in the transistor channel and this translates into a decrease of the depletion region. From the obtained plots, one can derive that the flat band voltage changed as a function of pH with an average rate of 22±1 mV/pH for the three tested FinFETs. The obtained sensitivity was less than what one would have expected (about 30 to 35 mV/pH). Without wanting to be bound by theory, the inventors explained this by defects introduced during the growth of the sensing oxide in a multi-purpose process chamber.

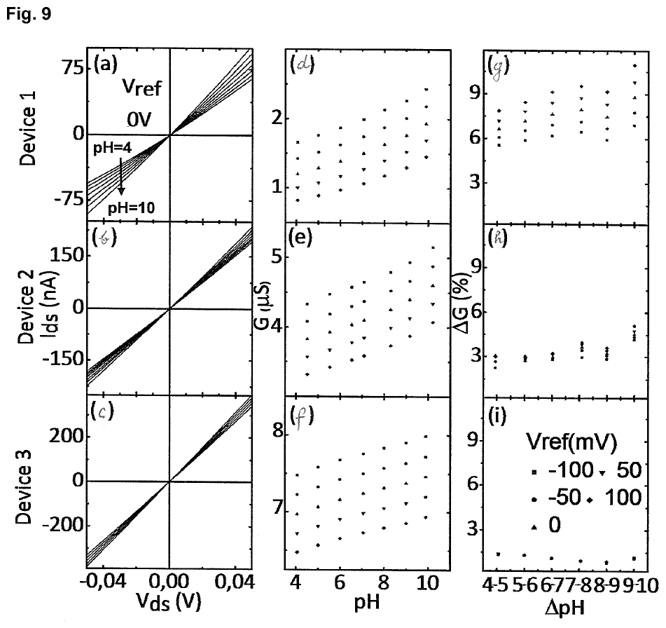

Graphs (a), (b) and (c) of FIG. 9 show the output characteristics of the three tested FinFETs at a fixed reference voltage V_{ref}=0 V for different pH values of the analyte solution. The conductance through the wire increased with increasing pH. The I_{ds} vs. V_{ds} characteristics of the devices remained nearly linear over the tested pH range (from pH=4 to pH=10), reflecting good ohmic behavior over a large range. Furthermore, the conductance values were evaluated at different pH values. Graphs (d), (e) and (f) show the conductance of the tested devices as a function of electrolyte pH at different fixed values of V_{ref} (from −100 mV to 100 mV in steps of 50 mV). One observes an increase in conductance with decreasing V_{ref}. This may be interpreted as the result of the attracting field experienced by the positive charge carriers in the semiconductor and the consecutively larger conducting cross section of the fins. The conductance of the devices increased nearly linearly with increasing pH.

The relative conductance change ΔG %=((G−G₀)/G₀))% was evaluated for each pH step at the different reference potentials V_{ref} (FIG. 9, (g), (h) and (i)). This was significantly higher for lower-width FinFETs, owing to the smaller dimensions and increasing impact of the depleted region. This is in contrast to the observed behavior in the transfer characteristics where the change in the surface potential of the oxide provided similar sensitivity for all the devices. Device 1 also exhibited a substantially linear increase of ΔG %, reflecting a quadratic dependence of the conductance from pH. The slope of ΔG % also increased with the applied reference voltage V_{ref}. In contrast, devices 2 and 3 exhibited an almost constant ΔG % as a function of pH. This behavior is in clear contrast with findings on NWs, which show a quadratic dependence due to the gating occurring in the two directions in contact with the electrolyte. Since the fins have an aspect ratio above 10, the depleted region (W_{D}) affects the conductance in the horizontal direction but the effect is much less (if not negligible) in the vertical direction (the relative change in h-W_{D} is much smaller than the relative change in W−W_{D}). This suggests that it is advantageous to measure the output characteristics of the FinFETs rather than the transfer characteristics.

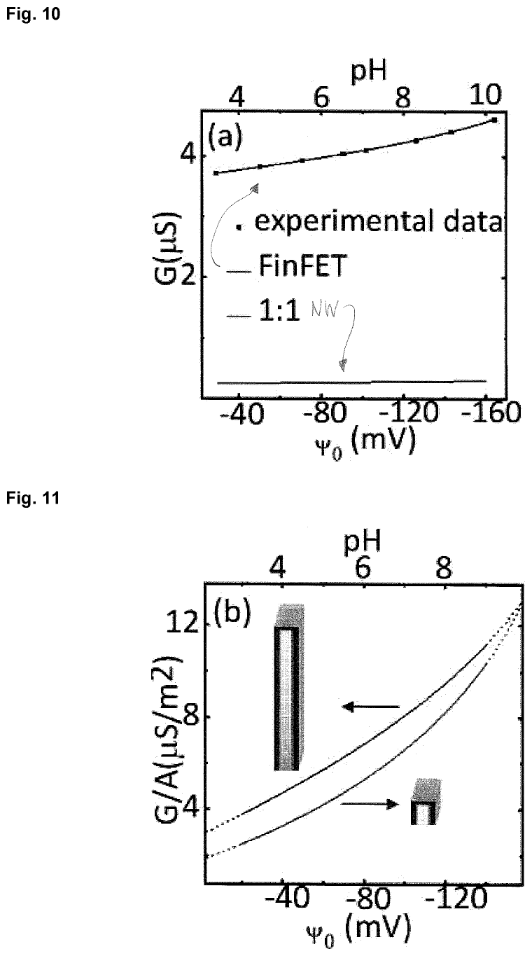

The results obtained with FinFET device 2 were compared with calculations for a nanowire with an aspect ratio of 1:1. FIG. 10 shows the conductance of FinFET device 2 vs. the change in the surface potential ψ₀ (the equivalent pH is shown in the top scale). The experimental data (black dots) were fitted to the theoretical model (Eqs. 4 and 5) for the used FinFET with a height/width aspect ratio of ˜12.7. With this simulation, the parameters of the oxide thickness and channel doping were retrieved, and it was found that they were in very good agreement with the ellipsometry calibration carried out during the growth of the oxide (20 nm in the calculation and the experimental data) and with the doping indicated by the manufacturer (fitting: 2·10¹⁷ cm⁻³, manufacturer information: 1-3·10¹⁷ cm⁻³). A calculated curve with the same parameters for a NW ISFET with an aspect ratio of 1:1 is also shown in the figure. The simulated response of the NW is nearly flat for the considered change in surface potential.

FIG. 11 reproduces the conductance of FIG. 10 normalized to the cross-sectional area. This is equivalent to compare the FinFET device with a NW array of 13 nanowires that would reach the same cross section. The curves have been extrapolated to bigger changes of the surface potential to achieve a fully conductive and fully depleted devices (dotted part of the graphs). Both devices would become insulating at about the same surface potentials (thus they would have similar dynamic ranges). However, it can be noticed that the FinFET offers a better linearity due to the effect mentioned above: whereas in the nanowire the depletion depends equally on the two physical transversal dimensions of the wire (W and h), in the FinFET the depletion depends to a much larger extent on the width (W), providing a double gate effect, while the vertical component of the depletion has a relatively low impact. As a result, the change in conductance is nearly linear. As a conclusion, while several NWs in parallel could provide similar current, a FinFET having the equivalent cross section provides better linearity, has a smaller footprint and optimizes the sensitivity for the full pH range.

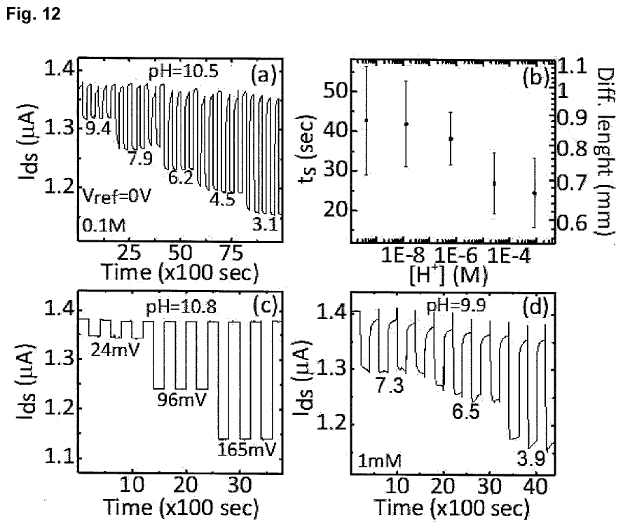

Finally, the current vs. time characteristics of a FinFET was studied. A real-time drain current measurement was implemented at fixed V_{ds} (200 mV) and V_{ref} (0 V) on FinFET device 2. The current at a fixed pH remained stable for long working time (3000 s, observed drift lower than 1 nA). The pH of the electrolyte was varied from a minimum of 2.55 to a maximum of 11.4 in multiple cycles to study the effect of the hysteresis. Additionally, pH measurements were carried out in real-time mode, in which the sensor was moved between solutions with different pH values. During these experiments, the temperature was kept close to zero ° C. in an ice bath. It was observed that the FinFET response was reproducible when the pH of the electrolyte (concentration: 0.1 M) was cycled several times between 10.5 and lower pH values in a range from 9.4 to 3.1 (FIG. 12 (a)). A slight drift of the maximum values of I_{ds} was observed. This could be due to incomplete change of pH and/or hysteresis.

During these measurements, a settling time for the FinFET device to reach equilibrium was observed. Using the current vs. time measurements, this settling time was measured when the electrolyte pH was varied from 10.5 to 7.9, 6.2, 4.5 and 3.1 values respectively (FIG. 12 (a)). The response was fitted with an exponential function y=A₁e^{(-x/ts)}+y₀, where A₁, tₛ and y₀ represent the fitting parameters. tₛ corresponds to a characteristic lifetime, which was considered as the settling time. The settling time is shown in FIG. 12 (b) and it can be observed that there was a characteristic time in the order of few tenths of seconds. To discard a capacitive effect as the origin of the settling time, the real-time response was measured by changing the reference voltage (FIG. 12 (c)). Specifically, the reference electrode voltage was increased from 0 to 24, 96 and 165 mV in multiple cycles, which would be equivalent to the change in surface potential produced by pH changes. Again, the drain current was measured vs. time at a fixed drain voltage and pH value. The current was stable at a particular V_{ref} and no settling time was observed at any of the V_{ref} values studied. A contribution to the settling time resulting from the ionic strength of the electrolyte could be discarded by measuring the real-time response at a different electrolyte concentration. FIG. 12 (d) shows I_{ds} as a function of the time for an electrolyte concentration of 1 mM. The obtained real-time pH response at two different electrolyte concentrations was similar and therefore it can be concluded that the change in electrolyte concentration has no or only negligible influence.

While not wishing to be bound by theory, the inventors interpret the settling time as an effect of the proton diffusion. The proton diffusion length corresponding to the diffusion time was also evaluated and is indicated in FIG. 12 (b). The calculation was made by considering the diffusion constant of protons in water (D_{H+}=9·10⁻⁹ m²/sec). For the obtained diffusion times the protons would diffuse towards the sensor surface from half to one mm. These distances are several orders of magnitude greater than the height of the fin. This is of particular interest in diffusion-limited processes. One could say that FinFETs according to the disclosure behave like planar sensors when the molecules or ions come from short distances (i.e. at normal or high concentrations), while their three-dimensional configuration significantly improves the diffusion limitation of the settling time at low concentrations when the molecules or ions arrive from farer distances. This aspect renders the FinFETs according to the disclosure particularly interesting for implementation as biosensors.

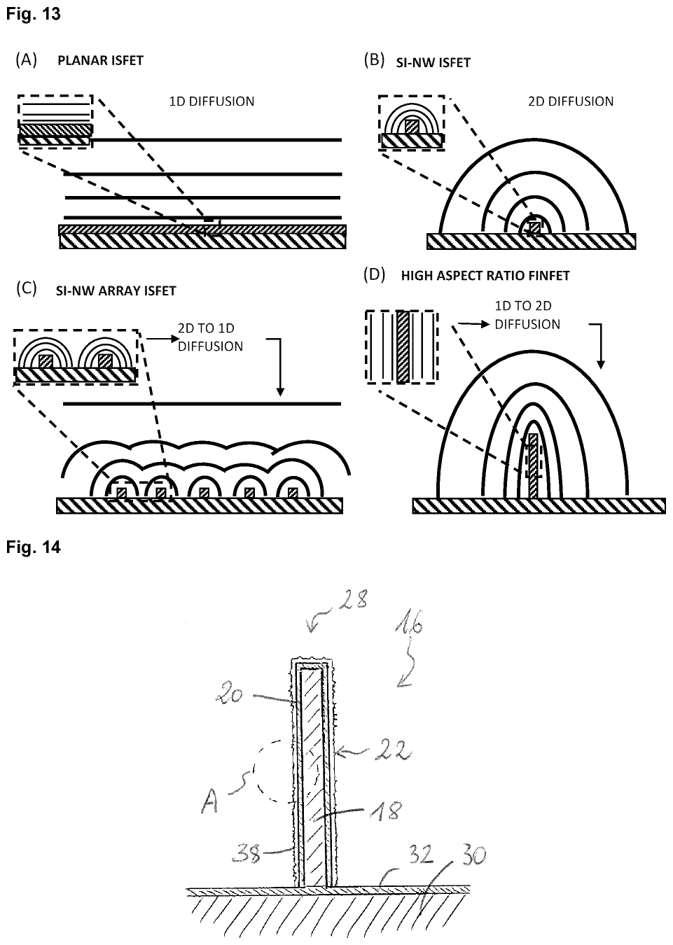

An ion or molecule is sensed as long as sticks to the sensor, which depletes the molecules in solution creating a gradient of molecules close to the sensor. FIG. 13 shows the diffusion fronts for different times and for different types of sensors. The illustrated diffusion fronts may be equated with iso-concentration planes during transients, i.e. when the analyte concentration is temporarily inhomogeneous due to the fact that analyte ions or molecules are drawn to the sensor surface. At high concentrations, the settling time is small, and most of the ions or molecules come from close to the sensor. In the case of a planar ISFET (FIG. 13(A)), the diffusion fronts change in one dimension perpendicular to the sensor. In the case of a NW (FIG. 13(B)) the diffusion fronts change also perpendicular to the sensor but in two directions. Accordingly, ions or molecules that have moved towards the sensor can be replaced by ions or molecules moving in from two dimensions. FIG. 13(C) shows what happens for a NW array with several NWs connected in parallel. At high concentrations the diffusion fronts also come from directions perpendicular to each sensor (zoomed area shown in the insert) but when the concentrations are lowered, the settling times are longer (because the ions or molecules necessary to reach the detection limit come from further away), and the diffusion fronts look like those of a planar ISFET. This is understood as fractal frustrated diffusion and makes NW microarrays lose part of their sensitivity with respect to the single NWs although they typically have better signal-to-noise ratios. In the case of a FinFET (FIG. 13(D)), at high concentrations (zoomed area in the insert), the diffusion fronts close to the sensor are similar to those of a panar ISFET although they come from two sides. At lower concentrations, the ions or molecules come from further away from of the sensor where the diffusion fronts change in two directions. This makes the FINFET efficient in the interesting range of low detection limits.

In accordance with Brownian motion, the diffusion length (L_{D}) associated to the diffusion time (τ) may be expressed as L_{D}=\sqrt{2Dτ}. As mentioned before, the measured diffusion length of sensors according to the disclosure is reported in FIG. 12(b) (right-hand vertical axis), where the diffusion constant of protons in water, D, was used as D=9·10⁻⁹ m²/sec. The further distance from which the protons diffuse towards the FinFET surface varies from half to one mm, which is three orders of magnitude larger than the height of the sensor. The reason for the small change of settling time observed in the FinFET (comparable to the standard deviation) is believed to be a consequence of the fast diffusion of protons. Other potential analytes of interest like DNA or proteins with slower diffusion constants and potential incubation times of hours, potentially have a behavior, in which the diffusion occurs differently depending on the initial concentration. When the initial concentrations is high, the analytes can reach the sensor from close to the surface, diffusing on planar concentration fronts parallel to the surface of the sensor with a double gating effect (“1D-diffusion”). At lower concentrations, associated with long incubation times, the analytes that will reach the sensor originate from further regions and the diffusion will become 2D (hemicylindrical) (FIG. 13 (D)). To provide a coarse comparison of the potential impact of FINFETs in the mass transport of other analytes, the inventors used the diffusion coefficients of haemoglobin and DNA strands of 21 nucleotides, but considering that the molecules would contribute to the signal similarly to protons (same changes in the surface potential). Within this approximation, in 43 seconds FINFETs would detect concentrations three orders of magnitude less for these biomolecules than for protons, while for detecting 0.1 nM (close to the proton concentration of pH 10) the time needed to reach equilibrium is in the order of 10⁴ seconds. Using the same approximation, the inventors compared the results for planar ISFETs (FIG. 13(A)) and a single NW (FIG. 13(B)). For a planar ISFET, they estimated that, in 43 seconds, concentrations in the order of μM would be detectable in the case of biomolecules, while, for the NW, the detection limit would be somewhat above 1 nM. Also, the time required to detect concentrations of 0.1 nM would be 10⁶ and 10³ seconds for a planar ISFETs and a NW respectively. In contrast with this, when the concentration of the analyte in the direct vicinity decreases, the FinFET changes from a traditional ISFET-like behavior to a more efficient diffusion in 2D, which provides an advantage when measuring slowly diffusing molecules at low concentrations.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the disclosure, which is to be given the full breadth of the appended claims and any and all equivalents thereof.

1. An ISFET or ISFET-based sensor, comprising
a source terminal, a drain terminal and a transistor channel between the source terminal and the drain terminal;
a fin extending between the source terminal and the drain terminal, the fin including the transistor channel, the fin having opposite sides with a charge-sensitive surface for forming an interface with an analyte solution and an insulating barrier between the charge-sensitive surface and the transistor channel located centrally between the opposite sides of the fin;
wherein the transistor channel has a length extending from the source terminal to the drain terminal, as well as a width and a height extending transversally to the length, the transistor channel having a height-to-width ratio of at least 10, a width in the range from 50 nm to 300 nm, a height in the range from 500 nm to 10 μm and a length in the range from 5 μm to 30 μm.

2. The ISFET or ISFET-based sensor as claimed in claim 1, wherein the insulating barrier comprises an oxide layer.

3. The ISFET or ISFET-based sensor as claimed in claim 2, wherein the oxide layer has a thickness of 30 nm or less.

4. The ISFET or ISFET-based sensor as claimed in claim 2, wherein the insulating barrier comprises a SiO₂ layer, an Al₂O₃ layer or a HfO₂ layer.

5. The ISFET or ISFET-based sensor as claimed in claim 1, wherein the insulating barrier comprises a surface functionalization that renders the charge-sensitive surface ion- or molecule-selective.

6. The ISFET or ISFET-based sensor as claimed in claim 1, wherein the fin protrudes from a semiconductor substrate.

7. The ISFET or ISFET-based sensor as claimed in claim 1, wherein the transistor channel is formed of p-doped silicon.

8. The ISFET or ISFET-based sensor as claimed in claim 1, wherein the transistor channel is formed of n-doped silicon.

9. The ISFET or ISFET-based sensor as claimed in claim 1, implemented as a junction-less field-effect transistor.

10. The ISFET or ISFET-based sensor as claimed in claim 1, wherein the transistor channel has a height-to-width ratio of at least 15.

11. The ISFET or ISFET-based sensor as claimed in claim 1, wherein the fin has a width in the range from 50 nm to 250 nm and/or a height in the range from 1 μm to 5 μm and/or a length in the range from 7 μm to 20 μm.

12. An ion- or molecule-sensitive device, comprising
an ISFET or ISFET-based sensor as claimed in claim 1, a chamber for receiving an analyte solution, the fin of the ISFET or ISFET-based sensor being arranged so as to protrude into the chamber, and
a reference electrode arranged for contacting the analyte solution.

13. Microfluidic sensor implemented as an ion- or molecule-sensitive device as claimed in claim 12, comprising a microfluidic protein sensor, a microfluidic biomolecule sensor, a microfluidic DNA sensor.

14. A microfluidic platform comprising a plurality of ion- or molecule-sensitive device as claimed in claim 12.

15. Method of using an ion- or molecule-sensitive device as claimed in claim 12, wherein the analyte solution is led into said chamber and wherein an electrical quantity dependent on conductance of the ISFET or ISFET-based sensor is measured when the analyte solution rests with respect to the chamber.

16. A microfluidic platform comprising a plurality microfluidic sensors as claimed in claim 13.

17. Method of using a microfluidic sensor as claimed in claim 13, wherein the analyte solution is led into said chamber and wherein an electrical quantity dependent on conductance of the ISFET or ISFET-based sensor is measured when the analyte solution rests with respect to the chamber.

18. Method of using a microfluidic platform as claimed in claim 14, wherein the analyte solution is led into said chamber and wherein an electrical quantity dependent on conductance of the ISFET or ISFET-based sensor is measured when the analyte solution rests with respect to the chamber.
